(19) United States
(12) Patent Application Publication
(10) Pub. No.: US 2023/0217949 A1
(43) Pub. Date: Jul. 13, 2023

(54) METHOD FOR PRODUCING A THREE-DIMENSIONAL CONFECTIONERY ITEM

(71) Applicant: Winkler und Dünnebier Süßwarenmaschinen GmbH, Rengsdorf (DE)

(72) Inventors: Rainer Runkel, Rengsdorf (DE); Holger Brack, Rümmelsheim (DE)

(21) Appl. No.: 17/996,572

(22) PCT Filed: Apr. 21, 2021
(86) PCT No.: PCT/EP2021/060319

§ 371 Date: Oct. 19, 2022

(30) Foreign Application Priority Data
Apr. 22, 2020 (DE) 10 2020 110 943.1

(51) Int. Cl. A23G 3/34; A23G 3/02

(52) U.S. Cl. CPC A23G 3/0031; A23G 3/0268

(57) ABSTRACT

The invention relates to a method for producing a three-dimensional confectionery item from at least one sugar mass (19, 28) using a casting mould (1) which can be assembled from at least two casting mould parts (2, 3, 15, 16), wherein each casting mould part has at least one partial cavity (5, 17, 18), with the proviso that the two casting mould parts (2, 3, 15, 16) can be brought into an assembled state in which the two partial cavities (5, 17, 18) produce a common mould cavity (8, 20) which gives the confectionery item its three-dimensional shape, wherein the two casting mould parts (2, 3, 15, 16) are arranged in an open casting position (PG) in which the partial cavities (5, 17, 18) are arranged so as to be open towards the top, and the two casting mould parts (2, 3, 15, 16) are then put together and brought into a closed transport position (PT).

The invention relates to a method for producing a three-dimensional confectionery item from at least one sugar mass using a casting mould, which can be assembled from at least two casting mould parts, wherein each casting mould part has at least one partial cavity, with the proviso that the two casting mould parts can be brought into an assembled state in which the two partial cavities produce a common mould cavity which gives the confectionery item its three-dimensional shape, wherein the two casting mould parts are arranged in an open casting position in which the partial cavities are arranged so as to be open at the top, that, in the casting position, a portion of the sugar mass of the confectionery item is poured into both partial cavities of the casting mould parts, that the two casting mould parts are then put together and brought into a closed transport position in which the casting mould is arranged horizontally, wherein the upper side of one casting mould part comes into contact with the upper side of the other casting mould part and the partial cavities of the two casting mould parts have lined up and form the common mould cavity.

Furthermore, the invention relates to a three-dimensional confectionery item, produced with the proposed method.

Confectionery items which are provided on opposite sides, for example top and bottom, with surfaces which in each case have a three-dimensional surface profile are described as three-dimensional.

In contrast to this, those confectionery items which have a surface profile only on one side but a flat surface opposite it, for example a confectionery item in the shape of a bar which is cast in a one-part casting mould with a cavity that is open at the top, are described as two-dimensional. Due to the flowability of the poured confectionery mass, a flat surface of the confectionery item develops in the cavity. Such a confectionery item is described in simplified terms as “two-dimensional”.

A generic method is known from DE 40 04 688 A1. In this prior art it is provided to form the two casting mould parts as so-called half-moulds from a foil. The foil is expediently to be deep drawn. After the production of the confectionery item, it is to remain in the folded-up foils, which then serve as packaging. To close this casting mould, one half-mould is folded about a pivot axis by 180° onto the other half-mould, with the result that the two rest on one another with their upper sides and form the mould cavity. The known casting mould parts are designed to be thin and light since they must subsequently serve as packaging foil, which is accompanied by a poor dimensional stability of the casting mould parts. The poor dimensional stability has a negative effect on the quality of the three-dimensional shape of the confectionery item that can be expected. If the pivot axis is realized merely as a fold groove or the like in the foil, as proposed, then this is also detrimental to the quality of the three-dimensional shape of the confectionery item.

Furthermore, another method for producing a three-dimensional confectionery item is known from EP 2 730 172 A1. This method operates by means of a permanent casting mould consisting of two casting mould parts with partial cavities. Here, the casting mould parts must first be put together to form an empty mould cavity. The sugar mass is then poured into the mould cavity through a filler opening.

The object of the invention is to further develop a generic method for producing a three-dimensional confectionery item from sugar mass such that confectionery items can be produced with a higher degree of accuracy of the three-dimensional shape.

The object is achieved according to the invention in that the casting mould is formed as a reusable permanent mould and, after the sugar mass has been poured in, the two casting mould parts of the permanent mould are moved first of all from the open casting position into a closed intermediate position in an intermediate step, in that, in the closed intermediate position, the partial cavities of the two casting mould parts are already lined up and the common mould cavity is formed, and in that, in a second step, the casting mould is then moved from the closed intermediate position into the horizontal transport position.

In the transport position, one casting mould part lies at the bottom and has returned to its horizontal starting position, while the second casting mould part rests on the casting mould part lying at the bottom in a mirror image.

The two casting moulds are aligned precisely during the closing procedure using a closing means of a suitable device for carrying out the proposed method.

A key advantage is achieved through the combination of the use of a permanent mould as well as a controlled movement of the two casting mould parts into the intermediate position and, in a second step, a further movement into the horizontal transport position. It is advantageous that, first of all, in order to reach the intermediate position, each of the two casting mould parts covers a distance which is shorter than the pivoting movement which the foil half-mould known from the prior art has to perform.

With the novel method, confectionery items with complex three-dimensional geometries can be produced, such as animals, people, articles of everyday use, e.g., a lightbulb. The confectionery items can therefore be asymmetrical. A separation of the confectionery item over its longitudinal direction is preferably provided for the partial cavities of the casting mould. This makes it easier to produce confectionery items which have complex asymmetrical three-dimensional geometries.

In contrast to the known method in which sugar mass is poured into an empty mould cavity through a filler opening, with the proposed method a completely closed mould cavity can be produced and a complete three-dimensional shaping of the confectionery item can be achieved. The finished confectionery item thereby has no indentations/defective areas, where the known method cannot achieve a three-dimensional shaping because of the filler opening. Instead, 100% of the confectionery item is moulded completely three-dimensionally on all sides, with no faults in its three-dimensionality.

In addition, the confectionery item has a tight and firm adhesion between the two portions of the sugar mass in the two partial cavities. When the two casting mould parts are put together, the surfaces of the poured sugar mass portions come into contact with one another and enter into a rapid material connection, which allows a one-piece confectionery item to form. The good connection of the sugar mass portions already acts against the confectionery item tearing apart when the casting mould parts are opened.

The sugar mass can be composed of the following ingredients: sugar: 25-75%, glucose syrup: 25-75%, preferably approx. 50%; water 5-30%, preferably 15-22%; additionally basic raw materials such as e.g. sorbitol (0.1-10%), inverted sugar syrup (0.1-10%), milk solids (0.1-10%), fruit concentrates or purees (0.1-20%); gelatin: gelatin (150-300 Bloom) 2-20%, preferably 4-10%; pectin: high- and/or low-ester and amidated, 1-10%, preferably 1.5-4%; agar: (kappa and/or iota quality) 1-10%, preferably 1.5-4%; carrageenan: 1-10%, preferably 1.5-4%.

Advantageously, gum arabic and starch as well as mixtures in combination with the binders gelatin, pectin, agar-agar and carrageenan can also be used for the sugar mass.

Furthermore, the following can be used as sugar masses for sweets: sugar 25-75%, preferably approx. 50%, glucose syrup 25-75%, preferably 50%, possible accompanying basic raw materials (see above), residual water content of from 0.5 to 5%, preferably 1.5-3%.

In general, the sugar masses for sweets can also comprise sugar-free raw materials (isomalt, maltitol, polydextrose, xylitol, etc.) in place of the sugar and/or the glucose—used quantities of these raw materials lie between 10 and 98%.

In addition, mixtures of the named sugar-free raw materials can be used in combination with the sugar mass for sweets. A sugar mass for sweets with a reduced sugar/glucose syrup content is used as a base. Sugar-free raw materials can also be used instead of the sugar/glucose syrup. A sugar-free raw material or a mixture of several sugar-free raw materials can be used, e.g., isomalt or maltitol.

The confectionery items can be of all possible pourable sugar masses, such as low-viscosity (thin) to high-viscosity (thick) and also have a paste-like or dough-like consistency. Even those sugar masses in which a yield point has been exceeded can be used. The sugar mass can have hygroscopic properties. The confectionery item is preferably a gum and/or jelly product. In addition, the sugar mass can also be marzipan. Marzipan has a paste-like or dough-like consistency. The sugar mass can also have a high proportion of a dry substance. In the case of a paste-like or dough-like sugar mass or from a certain viscosity, a mound-shaped surface develops after the sugar mass has been poured. During the closing procedure of the two casting mould parts, the mound-shaped surface in one partial cavity comes into contact with the sugar mass in the other partial cavity and is thereby displaced and distributed within the mould cavity formed.

In the recipe for the sugar mass it can be taken into consideration to guarantee that the finished confectionery item can be easily demoulded from the open casting mould.

A low viscosity of the hot casting mass and a rapid setting of the casting mass on cooling are important. A low water content, a gelatin with a high molecular weight and sugar with a high dry substance proportion are responsible for this.

Beyond the above-named ingredients, the confectionery item can also contain one or more of the following ingredients: pharmaceutical active ingredients, vitamins, flavourings, colours, concentrates.

To pour the sugar mass, the so-called one-shot method can be used, in which a “shot” is performed. A single nozzle which has only one channel for a single sugar mass can be used for the one-shot method. However, the one-shot method can also be performed with a nozzle which has several channels, through which different sugar masses can be poured in one “shot”. The channels can be arranged next to one another or, for example, as a central channel with one or more annular channels, which are arranged concentrically around the central channel. In the case of the last-named arrangement, depending on the number of channels, a so-called triple-shot nozzle is referred to if three channels are provided, or generally a multi-shot nozzle is referred to with an undefined number of channels.

To pour the confectionery mass into the partial cavities, an individual nozzle (single nozzle) which can pour a single sugar mass can be used for each partial cavity. Alternatively, a nozzle with several channels or groups of partial channels can be used in order to pour a matching number of different sugar masses through the same nozzle in a controlled manner corresponding to the number of channels or groups (e.g.: triple-shot nozzle).

With several single nozzles, e.g., a confectionery item can be produced for which different sugar masses are poured into one partial cavity. The sugar masses can be poured such that they are arranged next to one another or one on top of the other in the partial cavity.

In this way, for example, a confectionery item can be produced which has a shell made of a first sugar mass and arranged therein a core made of a second sugar mass. The first sugar mass can be realized such that it is transparent at the latest in the finished state of the confectionery item, with the result that the encased core, made of a high-contrast second sugar mass, for example, is clearly visible in the shell.

It has surprisingly also proved to be feasible to pour a semi-liquid second sugar mass as core or filling and to enclose this filling within the shell in a leakproof manner.

The closing movement for putting the two casting mould parts together is expediently time-controlled. In the case of a fixed path, a time is simply predefined and the speed results from this. In addition, an accelerated and a decelerated movement phase can be performed until the intermediate position is reached, namely the closing movement is performed accelerated at the start of the intermediate step out of the casting position and is performed decelerated before the upper sides of the casting mould parts come into contact. In addition to an acceleration and a deceleration, a phase with constant speed can also be predefined. Furthermore, a spring and/or damper system can be used in order to dampen or cushion the coming into contact of the upper sides of the casting mould parts.

During the closing movement, the casting mould parts can simply be rotated towards one another symmetrically about an axis of rotation into the intermediate position.

It is also helpful if the closing movement of the casting mould parts into the intermediate position is carried out so quickly that poured-in sugar masses in the two partial cavities can still join to one another when the partial cavities have been lined up and the casting mould is closed. The procedure of moving the two casting mould parts into the intermediate position during the intermediate step is facilitated by a partial solidification of the sugar mass inside the two partial cavities. The partial solidification makes it possible to close the two casting mould parts without sugar mass running out of the partial cavities in the process. However, the sugar mass is still in a soft or sticky state which makes it possible for the two sugar masses which are located in the two partial cavities to join in order to become a single body, which results in the finished confectionery item. The important factor for the partial solidification is the time which has passed between the pouring procedure and reaching the intermediate position. It is to be noted that the closing movement has only a slight influence on the partial solidification because of its speed.

Advantageously, the closing movement until the intermediate position, in which the partial cavities of the casting mould parts are lined up, is reached can be performed within a closing time which lies in the range of from 0.1 to 3 seconds.

In order to rotate the two casting moulds about the axis of rotation in an accelerated manner and to slow them down again in time such that the surfaces can be placed against one another in the intermediate position and with positional accuracy, various movement profiles can be used, which can be simply represented in a two-dimensional Cartesian coordinate system with the angular path, the angular speed and the angular acceleration as a function of time. The simplest case is a triangular profile in which an angular path beginning at a 0° starting position into a 90° intermediate position is performed. The triangular profile describes the angular speed as a function of time. The first half of the angular path is effected as an acceleration phase until a sharp bend in the movement profile and thereafter the second half of the angular path is effected as a deceleration phase. Both the angular path of the individual casting mould parts into the intermediate position and the non-represented angular path of the combined casting mould from the intermediate position into its transport position are in each case covered with constant angular acceleration or deceleration.

Expediently, the stepwise movement of the casting mould from the intermediate position into the transport position is performed within a depositing time which lies in the range of from 0.1 to 3 seconds.

Besides the triangular profile mentioned, a trapezoidal profile is possible, in which the casting mould parts are first moved with a phase of constant angular acceleration starting from the 0° position, then into a phase with constant angular speed and finally into a phase of decelerated angular movement into the 90° intermediate position.

In addition, movement profiles without sharp bends, which make a smooth movement possible, can be taken as a basis as a polynomial function. The movement likewise begins in each case in a 0° starting position, from which the two casting mould parts are moved symmetrically towards one another into the 90° intermediate position, before they then return, in the folded-up state as a combined casting mould, to the 0° position, which corresponds to the transport position of the casting mould.

A particular benefit of the method is seen to be that two different sugar masses are poured into at least one partial cavity of a casting mould part, and that the different sugar masses are poured into the partial cavity next to one another or one on top of the other. In this way, complex three-dimensional confectionery items can be produced.

In order to obtain a consistency of the sugar mass that is expedient for the proposed method, the sugar mass is poured into the partial cavities of the casting mould parts at a pouring temperature in a particular temperature range, depending on its composition, namely:

pectin gel 70-100° C.,
gelatin 50-90° C., preferably 65-75° C.,
carrageenan 90-110° C., preferably 100-110° C. and
agar 35-70° C., preferably 45-55° C.,
hard caramel 80-150° C., preferably 120-140° C.,
toffee or soft caramel 80-120° C., preferably 90-110° C.

In order to be able to carry out the method for producing a three-dimensional confectionery item from at least one sugar mass expediently, a device for this is proposed, comprising at least one casting mould, which has at least two casting mould parts which can be assembled, wherein each of the casting mould parts is provided with at least one partial cavity, wherein, when they are lined up, the partial cavities form a mould cavity, and comprising a handling unit with a holding mechanism for at least one of the casting mould parts and with a pivoting mechanism with which the casting mould part is movable, wherein a control unit is provided, with which the movement dynamics for the closing movement of the casting mould parts from the casting position into the intermediate position and the movement dynamics for the pivoting movement of the casting mould parts from the intermediate position into the transport position can be controlled.

Expediently, at least one casting mould part has on its upper side an annular rim which surrounds the partial cavity and protrudes at the upper side. The annular rim is an elevation on the upper side. Its inner side forms the upper region of the partial cavity. When the upper sides are put together, the annular rim of one casting mould part meets the upper side of the other casting mould part. The upper side of the other casting mould part can be flat or, for its part, have an annular rim. In any case, a certain force is exerted, which presses the upper sides against one another. A high contact pressure forms at the protruding annular rim. The high contact pressure brings about a sealing of the mould cavity, which has formed due to the partial cavities being placed against one another. If there was more sugar mass in the two partial cavities together than fits into the mould cavity, then the excess portion is squeezed out when the partial cavities are put together. Due to the high contact pressure at the annular rim, the squeezed-out excess portion of the sugar mass is severed from the sugar mass inside the mould cavity, with the result that the mould cavity, completely closed and completely filled, can produce a confectionery item of good quality.

In order to facilitate the above functionality, the annular rim is expediently formed as a separating wedge. It has a stable, wedge-shaped cross section, wherein the cross-sectional shape can be a blunt wedge which has a free edge surface, which can rest flat against an opposite upper side.

In an advantageous design, the casting mould is provided with positioning means in order to align the two casting mould parts relative to one another when the upper sides thereof come into contact with one another.

Magnets and/or centring pins and complementary centring openings can simply be provided as positioning means. Centring pins and openings can be provided at two corners of a casting mould, for example, in order to prevent two casting mould parts from slipping relative to one another as soon as the centring pins are pressed into the centring openings. This alignment achieves a fixing of the casting mould parts, which also holds the casting mould parts securely on one another in subsequent method steps.

Magnets serve primarily to hold the casting mould parts together and bring about a certain clamping force, which forces the casting mould parts, or respectively their upper sides, against one another. The magnets also contribute to the positioning. In order to close the casting mould securely, a larger clamping force than the magnets provide may be necessary. For this, a clamping force can be produced by means of an external clamping means. The clamping means is capable of producing a clamping force which can guarantee the secure closing of the casting mould parts. In addition, it can be the case that sugar mass protrudes beyond the partial cavity and forms a point, like in a meringue. To close the casting mould, the protruding sugar mass must be deformed. A certain clamping force is necessary in order to be able to press the casting mould parts tightly together and to distribute the sugar mass in the mould cavity. A suitable device for carrying out the proposed method for producing three-dimensional confectionery items provides a closing means, which is designed to transfer the required clamping force into the casting mould parts so that they can be clamped against one another to a sufficient degree in order to close the mould cavity tightly.

Advantageously, at least one of the casting mould parts is realized as a permanent mould made of a rigid plastic, such as polycarbonate or one of its copolymers.

Moulds made of this rigid plastic are advantageous because of the lower mould costs. The term “rigid plastic” is used here to differentiate from rubbery-elastic plastics. Such plastics are not completely brittle or malleable but rather are still elastically deformable within certain limits. They can be both thermosetting plastics and thermoplastics. Thermoplastics are preferred because of the easier processing, but it must be ensured that they retain their strength to beyond the pouring temperature of the sugar mass. Suitable plastics are, for example, polycarbonate and the copolymers thereof.

Moulds made of rigid plastic are much more cost-effective than those made of aluminium, rubber, elastomers or silicone. Also, they do not require any supporting constructions and expensive demoulding devices.

In order to support the demouldability of a finished confectionery item, a release agent can be used, which is applied before the sugar mass is poured in, in order to wet the shaping surface of the partial cavity with it. Fats and oils of vegetable origin or waxes can be used as release agent. For example, palm, palm kernel, coconut, soybean and sunflower oil are suitable. Examples of suitable waxes are carnauba wax and also beeswax. Mixtures of various of these substances can also be applied. A release agent can additionally contain additives such as solvents, thinners and wetting agents. All suitable release agents and additives must be approved for use in foodstuffs. An extremely thin layer of the release agent is sufficient, for example a layer thickness of 20-44 μm. The wetting can be effected with known methods, for example spreading on, flushing, spraying on. In order to achieve a thin coating, the release agent can expediently be set to a low viscosity, for example 50-150 mPas, by heating or through the addition of thinners.

The invention is represented by way of example and described in detail below with reference to several figures in a drawing. There are shown in:

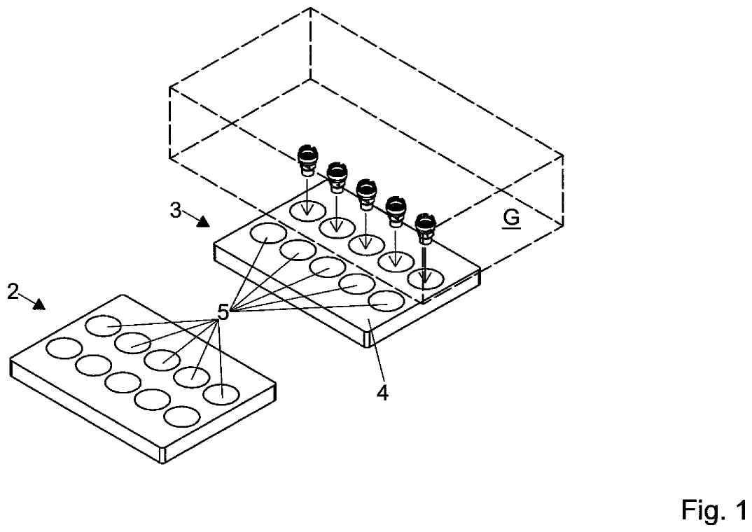

FIG. 1 a perspective representation of two casting mould parts in the open casting position,

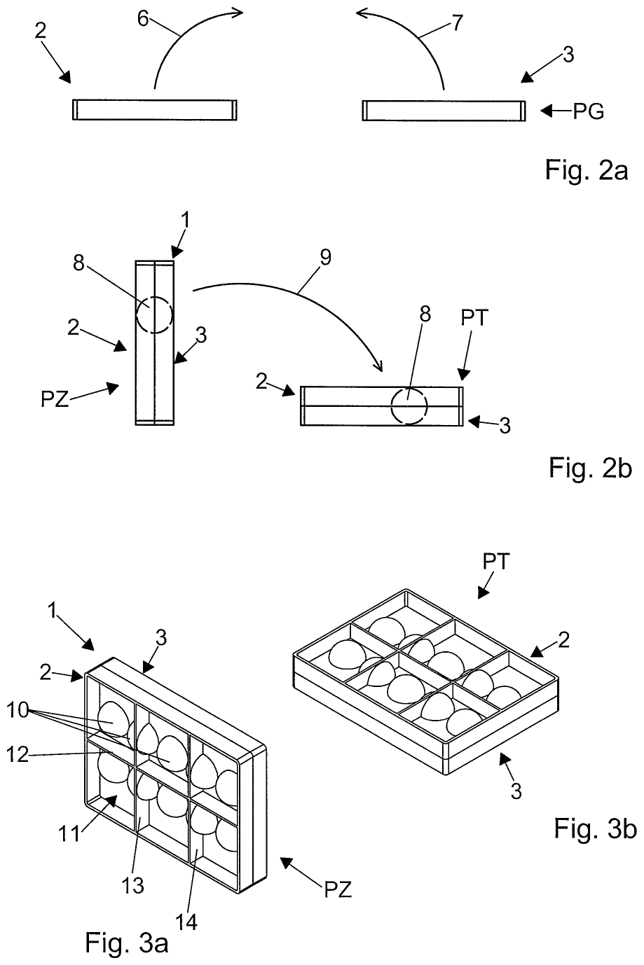

FIG. 2a a schematic representation of the casting position according to FIG. 1,

FIG. 2b a schematic representation of an intermediate position with casting mould parts put together, which form a closed casting mould, and the casting mould in a transport position,

FIG. 3a a perspective representation of the intermediate position according to FIG. 2b,

FIG. 3b a perspective representation of the transport position according to FIG. 2b,

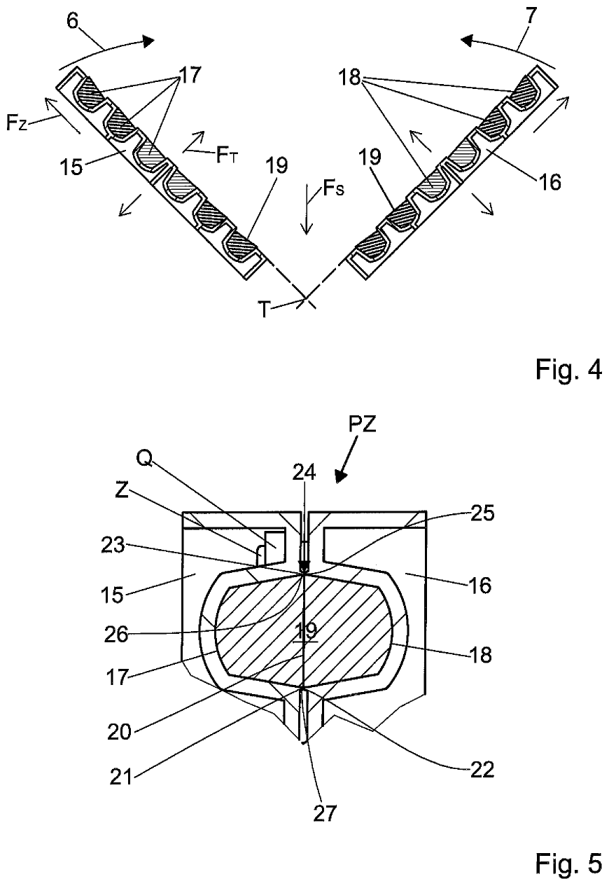

FIG. 4 a sectional representation through two casting mould parts during a closing movement,

FIG. 5 shows an enlarged section of the casting mould according to FIG. 4 in the intermediate position with closed mould cavity,

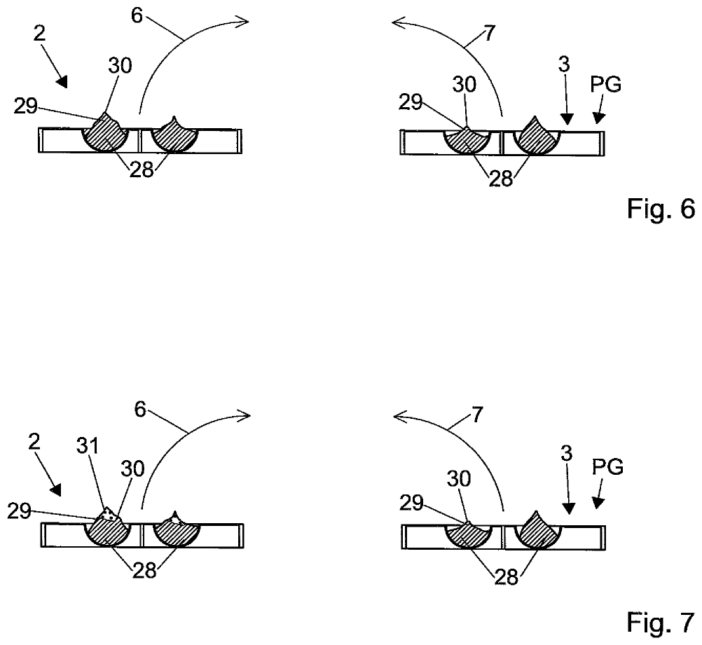

FIG. 6 casting mould parts in the casting position with sugar mass poured in,

FIG. 7 casting mould parts in the casting position with sugar mass poured in and a further ingredient,

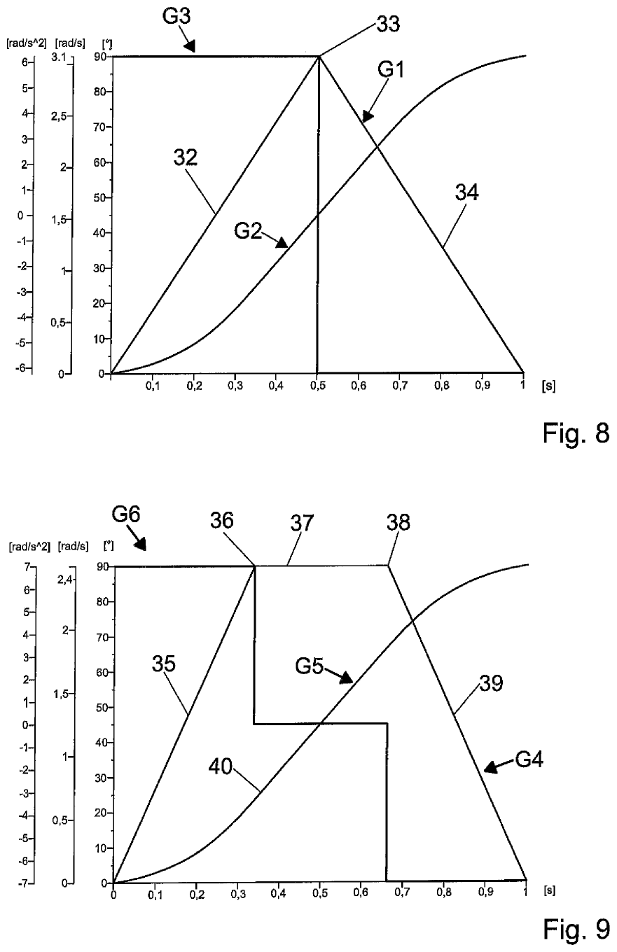

FIG. 8 a first movement profile for the casting mould parts,

FIG. 9 a second movement profile for the casting mould parts,

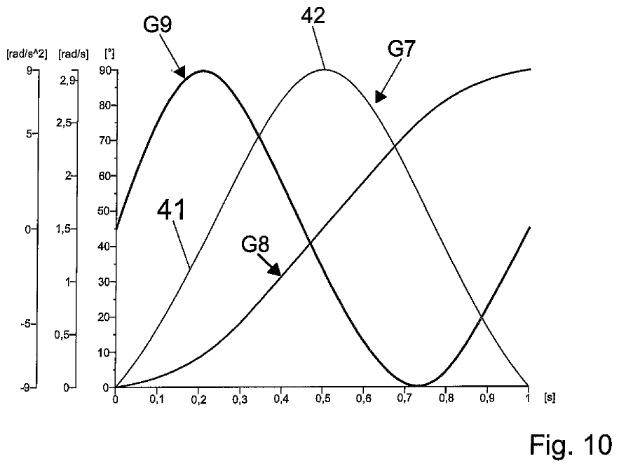

FIG. 10 a third movement profile for the casting mould parts,

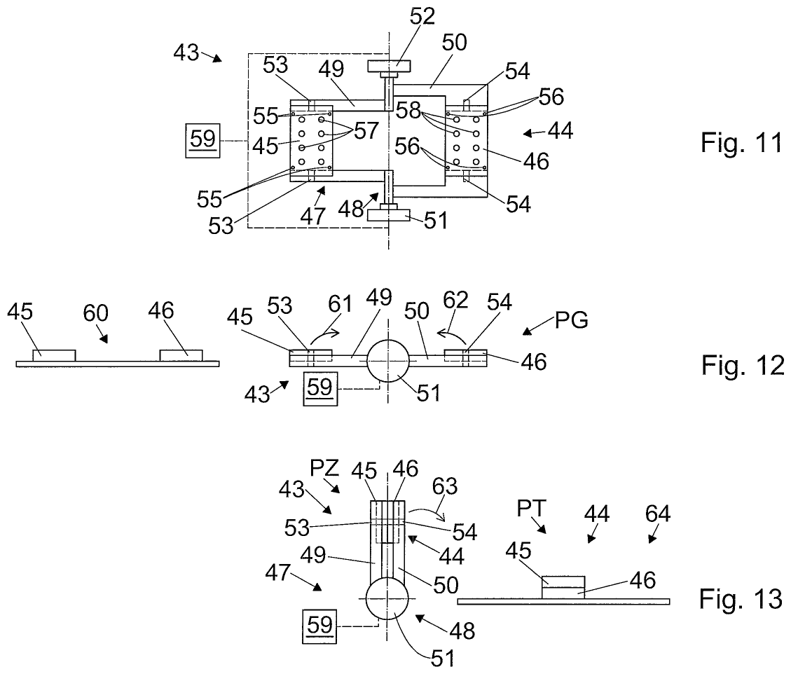

FIG. 11 a top view of a device for carrying out the method,

FIG. 12 a side view of the device according to FIG. 11 in the casting position,

FIG. 13 a side view of the device according to FIG. 12 in the intermediate position.

FIG. 1 shows a casting mould 1, namely the two casting mould parts 2 and 3 thereof are represented in perspective next to one another in a plane. The casting mould 1 is provided for producing a three-dimensional confectionery item from at least one sugar mass according to the method proposed here. In FIG. 1, it is open. The casting mould parts 2 and 3 are thus in a casting position PG because, in this flat arrangement, each casting mould part can be moved to a casting machine G, with which sugar mass can be poured in. To receive the sugar mass, in the example of casting mould part 3 it is shown that an upper side 4 is provided in each case with ten partial cavities 5. The partial cavities 5 are arranged on the upper side 4 in two rows of five partial cavities. In this example, the sugar mass is poured into the partial cavities one row after the other by the casting machine G.

FIGS. 2a and 2b show schematic representations of the two successive movement steps of the casting mould 1 or the casting mould parts 2 and 3, respectively. According to FIG. 2a, the casting mould 1 is open. The casting mould parts thereof are in the casting position PG in a plane. The direction of a symmetrical closing movement, with which the casting mould parts 2 and 3 can be put together and adopt an intermediate position PZ, as shown in FIG. 2b, is indicated with arrows 6 and 7. According to this, the upper sides have each been rotated by an angle of 90°. In the intermediate position PZ reached in this way, the upper sides of the casting mould parts 2 and 3 touch. The variant described here in detail, with a symmetrically rotating closing movement of the two casting mould parts into the 90° intermediate position, is preferred. However, other movement forms are also possible, in which the intermediate position lies at an angle which is smaller or larger than 90°. Thus, for example, one casting mould part can be rotated by 89° and the other casting mould part can be rotated by 91° in the opposite direction, or one casting mould part can be rotated by 10° and the other casting mould part can be rotated by 170° in the opposite direction, in order to obtain the closed casting mould. The partial cavities 5 of the two casting mould parts 2 and 3 have been lined up and form a mould cavity 8 closed on all sides, which gives the contained sugar mass the desired three-dimensional shape.

The following movement step is also shown in FIG. 2b by means of an arrow 9. This is a pivoting movement, which moves the casting mould parts 2 and 3 together as an already closed casting mould 1 from the intermediate position PZ into a transport position PT through a rotation by 90°. In the transport position PT, the casting mould part 3 has returned to the position which it was in at the start in the casting position, which is shown in FIG. 2a. The casting mould part 2 has left its initial position and is now upside down on the casting mould part 3 with its partial cavities pointing downwards. Together with the partial cavities 5 of the casting mould part 3, mould cavities 8 are formed.

A perspective view of the casting mould 1 in the intermediate position PZ is shown in FIG. 3a and a perspective view of the casting mould 1 in the transport position PT is shown in FIG. 3b. The casting mould 1 has dome-shaped partial cavities, the outer wall 10 of which can be seen in each case on an underside 11 of the casting mould part 2. Moreover, dividers 12, 13 and 14, which promote the dimensional stability of the casting mould part 2, are arranged on the underside 11. Furthermore, the underside 11 is effectively hollow, which saves material and weight.

A sectional representation through two casting mould parts 15 and 16 of another casting mould during a closing movement about an axis of rotation T is represented in FIG. 4. In the cross-section shown, the casting mould part 15 has six partial cavities 17 and, in the cross-section shown, the casting mould part 16 is provided with six partial cavities 18. The partial cavities 17 and 18 are filled with sugar mass 19. During the closing movement, forces which result from the dynamics of the closing movement and gravity Fₛ act on the sugar mass 19 in accordance with the arrows 6 and 7. Moreover, adhesive forces act at the interface between the sugar mass and the partial cavity and cohesive forces act within the sugar mass 19. The greater the cohesive forces in the sugar mass 19 are, the greater is the internal friction and thus the viscosity. The viscosity is in turn a measure of the resistance of the sugar mass 19 to shear, i.e., to flow processes. The greater the viscosity of the sugar mass 19 is, the greater a force must be in order to make it flow in a certain way in a certain time period. At the same time, gravity F_{S} is acting if a flow process of the sugar mass 19 takes place downwards out of the partial cavity 17 or 18 during the closing movement. Because of the dynamics of the closing movement, a generated centrifugal force F_{z} counteracts this and brings about a flow of the sugar mass 19 in the radial direction away from the axis of rotation T. At the same time, the cohesive forces within the sugar mass 19 counteract the flow processes in the sugar mass 19.

The duration of the closing procedure must be adapted such that the influences of the centrifugal acceleration (the quicker the closing procedure, the greater the centrifugal force) and the influences of the gravitational force in the centre of the mould cancel each other out to the greatest possible extent. Due to the forces in the centre of the mould almost being in equilibrium, the confectionery mass flows as little as possible. If the viscosity of the confectionery mass is sufficiently high, it can even be prevented from flowing out beyond the rims of the cavity. A deceleration phase is provided, which brings about an inertia force F_{T} on the sugar mass, which expels it from the partial cavity perpendicular to the surface of a casting mould part. On the other hand, the cohesive force provides for the cohesion of the sugar mass and counteracts it melting or running and the adhesive force causes the sugar masses not to flow out of the partial cavities.

Through a selection of a suitable recipe or a suitable composition of the sugar mass 19, the flow process thereof can be slowed or adjusted such that its viscosity is matched in an expedient manner to the dynamics of the closing movement of the casting mould parts 15 and 16. The flow process can also be influenced by a partial solidification, namely in the time period between the pouring procedure and the closing movement of the two casting mould parts of a casting mould. It is expedient if the internal flow processes during the closing movement proceed so slowly that no sugar mass 19 or only a small amount of sugar mass can flow beyond the rims of the partial cavities 17 and 18 during the duration of the closing procedure, wherein in addition the sugar masses are then still in a state in which they can join to one another in a material sense when the surfaces thereof meet when the mould cavity is closed. Thus, the meeting surfaces of the sugar masses are then still to have a certain “stickiness”.

In the example represented in FIG. 4, a little less sugar mass 19 has been poured into each partial cavity 17 or 18 than the maximum that the partial cavity can hold. In the partial cavities, the surfaces of the sugar mass 19 adjust themselves according to the forces acting on them. In the example shown, the fill level is chosen in this way. At the partial cavity which is furthest away from the axis of rotation T, the centrifugal force F_{z} is not so large that the sugar mass 19 would overflow radially outwards and at the partial cavity which is closest to the axis of rotation T, the force of gravity Fₛ is not so large that the sugar mass 19 would run out downwards. In order to achieve this, initially in the casting position PG less sugar mass was poured into the partial cavity (17, 18) than the maximum that would have fitted in. The fill level of the sugar mass 19 is below the rim of the partial cavity (17, 18).

Sugar mass would then overflow if gravity can act on the sugar mass for sufficiently long. Sugar mass can be prevented from overflowing out of a partial cavity through a targeted matching of the time, viscosity of the sugar mass and dynamics of the closing movement. In this way, a larger volume of sugar mass 19 can be poured in. The volume of the sugar mass poured in can thus be reconciled with the actual volume of the partial cavity (17, 18).

FIG. 5 shows an enlarged section of the casting mould from FIG. 4 in the intermediate position. The casting mould parts 15 and 16 are put together and the two partial cavities 17 and 18 thereof form a closed mould cavity 20, which is completely filled with sugar mass 19. An annular rim 21 is provided on the partial cavity 17 and an annular rim 22 is provided on the partial cavity 18. The two annular rims protrude in each case at the upper side. The annular rim 21 has a blunt wedge-shaped cross-section 23, which forms a separating wedge 24. The separating wedge 24 has an annular separating surface 25, which is arranged parallel to the upper side of the casting mould part 15. The separating surface 25 has a small surface area, as a result of which it achieves a high contact pressure when it comes into contact and is pressed together with the casting mould part 16 when the two casting mould parts are put together. An inner side 26 of the separating wedge belongs to the shaping partial cavity 17 and, with it, forms a continuous inner surface. The annular rim 22 has an identical design to the annular rim 21. In principle it is also possible to dispense with one of the annular rims. If only one annular rim 21 is provided on the casting mould, then it is arranged on the casting mould part which lies at the bottom in the transport position. An annular rim has an advantage in particular when an excess portion of sugar mass 19 is squeezed out of the mould cavity. For one thing, the excess portion of sugar mass is severed from the sugar mass 19 inside the mould cavity due to the high contact pressure. In addition, the squeezed-out excess portion of sugar mass has space on an outer side 27 of the annular rim 21. Without an annular rim, the excess sugar mass would be distributed over a wide area on the upper side of the casting mould part, which disadvantageously produces an increased cleaning effort. If two annular rims 21 and 22 are provided, this has the advantage that any casting mould part can optionally be used at the top or the bottom in the transport position. This is true at least when the partial cavities are symmetrical at the top and the bottom because the confectionery item to be moulded has a symmetrical shape. On the other hand, for asymmetrical three-dimensional confectionery items, two types of casting mould parts are needed, in the case of which the top and bottom cannot be interchanged. In order to fix the relative alignment of the two casting mould parts, the casting mould part 15 is provided with two centring pins, like centring pin Z shown in the section, and the casting mould part 16 is provided with two complementary centring openings Q.

FIG. 6 shows the casting mould parts 2 and 3 according to FIG. 2a in the casting position PG with sugar mass 28 poured in. In this case, the sugar mass 28 is in a still soft or sticky state. It is partially solidified to a degree or has a viscosity of a level such that it forms a mound 29, which has a raised surface 30 which protrudes partially above the partial cavity and only flattens out very slowly. The cohesion acting within the sugar mass can be influenced such that the raised surface 30 of the mound 29 persists sufficiently long to perform the closing procedure of the casting mould parts 2 and 3, which moves them from the horizontal casting position PG into the intermediate position in which the casting mould is closed. Raised mounds 29 of sugar mass 28 are located in the two partial cavities which are put together to form a mould cavity. During the closing movement, the raised mounds 29 of the two casting mould parts 2 and 3 meet and are pressed together such that they are deformed, wherein the sugar mass is distributed in the partial cavities and fills them. The mounds 29 are then still sticky on the surfaces 30, which allows the sugar masses 28 to join to one another and to become a single body, which results in the finished confectionery item. Ideally, sugar mass 28 is poured into the partial cavities in a quantity the volume of which is identical to the volume of the partial cavity, or, in total, a volume is poured into both partial cavities which corresponds in total to the volume of the mould cavity.

Alternatively, it is possible to pour the sugar mass 28 in in a quantity which in total slightly exceeds the volume of the mould cavity. In this case the mould cavity is completely filled, and an excess portion of sugar mass is pressed out of the mould cavity formed when the casting mould is closed. The excess sugar mass can be severed from the sugar mass by means of an annular rim (not represented), according to the principle as described with reference to FIG. 4.

Another alternative provides for pouring in less sugar mass 28, which in total is slightly less than the volume of the mould cavity. In this case the mould cavity may not be completely filled, but rather a small gap in the mould cavity is accepted, which remains empty or contains air. It is to be taken into consideration that the accuracy of the casting machine does not allow high-precision metering as a rule. Taking into consideration a metering error of the casting machine predefined in device-technology terms, it can either be set such that in total over-metering takes place, with the result that an excess portion of sugar mass 28 must be squeezed out of the mould cavity, or the casting machine is set such that in total under-metering takes place so that a gap forms in the mould cavity. The size of the gap can be minimized. It must not be larger than the volume which corresponds to the metering error of the casting machine.

A further example is represented in FIG. 7, which is in turn based on the casting mould parts 2 and 3 according to FIG. 2a in the casting position PG. In contrast to the example of FIG. 6, here a second ingredient 31 has been poured in in addition to the sugar mass 28, namely in each case in one of the partial cavities of a mould cavity. This ingredient can be a further sugar mass or, for example, an insertable solid ingredient, such as a nut, etc. If the ingredient 31 is a sugar mass, it can be partially solidified to a degree such that, although it sticks to the first sugar mass 28, it does not mix with it at all or mixing only takes place in a defined layer. Furthermore, over-metering or under-metering can also take place in this example in order, in the total of the sugar mass 28 including the further ingredient 31, to have metered more or less into the partial cavities than corresponds to the volume of the mould cavity formed.

In order to move the casting mould or the two casting mould parts about the axis of rotation into the intermediate position it is expedient to control the time of the closing movement. It is also beneficial if the pivoting movement from the intermediate position into the transport position is also performed in a time-controlled manner. FIGS. 8, 9 and 10 give examples of correspondingly time-controlled movement profiles, which are simply represented in a two-dimensional Cartesian coordinate system with the angular speed [rad/s] against time [t]. Moreover, in each case a graph (function graph) is plotted, which represents the angle against time as well as a graph for the angular acceleration against time [rad/s²].

A triangular profile is represented in FIG. 8. It relates to the angular speed of the rotating closing movement of the casting mould parts, starting from a 0° casting position PG into a 90° intermediate position PZ, which is reached after t=1.0 seconds. Not depicted here is the subsequently necessary pivoting movement of the closed casting mould from the 90° intermediate position PZ into the 0° transport position PT, which can also be time-controlled.

In the triangular profile of FIG. 8, the angular speed increases to t=0.5 seconds. This is an acceleration phase, which is represented in a graph G1 as a rising straight line 32 in the triangular profile. Then, a sharp bend 33 is effected and the angular speed decreases again to t=1 second, which means a deceleration phase, which is represented as a falling straight line 34 in the triangular profile. In addition, the angle against time is represented as a further graph G2 in FIG. 8. According to this, the 90° intermediate position is reached after t=1 second. In addition, the angular acceleration against time [rad/s²] is represented as a third graph G3.

The movement profile represented in FIG. 9 is trapezoidal. In a graph G4, the trapezoidal profile likewise has an acceleration phase, which ends after approx. t=0.3 seconds and is represented as a rising straight line 35. This straight line transitions into a horizontal line 37 with a sharp bend 36, i.e., into a phase with constant angular speed. The horizontal line is in turn connected with a sharp bend 38 to a deceleration phase, which is represented as a falling straight line 39, which starts at approx. t=0.7 seconds and has slowed down to 0 rad/s after t=1 second. Moreover, the angle is plotted against time as graph G5, which reaches the 90° intermediate position after t=1 second, wherein in the centre between the acceleration phase and the deceleration phase a straight line 40 is represented, which shows the phase with constant angular speed, and the angular acceleration is in turn shown as graph G6.

In addition, an angular speed-time curve can be provided, the graph G7 of which is designed as a polynomial function 41, as in FIG. 10. This graph without sharp bends likewise has at least an acceleration phase and a deceleration phase, which transition into one another at a maximum 42. The example of FIG. 10 is a fifth-degree polynomial. In addition, in FIG. 10 the angle is plotted against time as graph G8, which reaches the 90° intermediate position after t=1 second, in which the casting mould parts are put together and the casting mould is closed, and the angular acceleration is in turn shown as graph G9.

The pivoting movement of the closed casting mould from the 90° intermediate position PZ into the 0° transport position PT, that is not depicted, can also have an acceleration phase and a deceleration phase.

FIGS. 11, 12 and 13 show a device 43 for carrying out the proposed method for producing a three-dimensional confectionery item. FIG. 11 is a top view of the device 43. It comprises a casting mould 44, which has two casting mould parts 45 and 46 which can be assembled. Furthermore, the device comprises a handling unit 47 with a pivoting mechanism 48. The pivoting mechanism is provided with two pivoting carriers 49 and 50 and each pivoting carrier is provided with a pivot drive 51 and 52. A holding mechanism 53 or 54, respectively, is assigned to each pivoting carrier for detachably fixing one of the two casting mould parts 45 and 46. During a closing movement, each casting mould part 45 and 46 is fixed to its corresponding pivoting carrier 49 or 50, respectively. As soon as the intermediate position PZ is reached and the casting mould 44 is closed, the holding mechanism 53 detaches the fixing from the pivoting carrier 49 and releases the casting mould part 45. In the present example, the casting mould part 45 is provided with magnets 55 and the casting mould part 46 is provided with magnets 56, which together attract the released casting mould part 45 to the other still fixed casting mould part 46 and position them. The positioning is mainly effected by positioning pins and complementary positioning openings and also by the holding mechanisms 53 and 54 of the pivoting carriers 49 and 50. The casting mould part 45 is provided with partial cavities 57 and the casting mould part 46 is provided with partial cavities 58, which in the intermediate position are lined up in pairs. Each pair of closed partial cavities 57 and 58 then forms a mould cavity for a confectionery item.

In addition, a control unit 59 is provided, with which the movement of the casting mould parts 45 and 46 can be controlled and a dynamic movement can be produced, as explained above with reference to the movement profiles of FIGS. 8, 9 and 10.

FIG. 12 represents a side view of the device 43 according to FIG. 11 as well as a transport means 60, which supplies the casting mould parts 45 and 46 filled with sugar mass and transfers them to the device 43. According to FIG. 12, the pivoting carriers 49 and 50 are located in a horizontal position, with the result that the casting mould parts 45 and 46 coming out of a casting machine are still arranged in a plane relative to one another, which is thus described as casting position PG. The casting mould part 45 is fixed to the pivoting carrier 49 by means of the holding mechanism 53 and the casting mould part 46 is similarly fixed to the pivoting carrier 50. The casting mould parts 45 and 46 are pivoted from the casting position PG into the intermediate position PZ, which is shown in FIG. 13, in accordance with the arrows 61 and 62. In the intermediate position PZ, the casting mould 44 is closed and the holding mechanism 53 of the casting mould part must then be detached while the holding mechanism 54 holds the other casting mould part 46 and in addition the casting mould part 45 fixed. Along the arrow 63, the closed casting mould 44 is then pivoted into the transport position PT. In the transport position PT, the still fixed casting mould part 46 then lies at the bottom and its fixing is now also detached. The casting mould 44 is then transferred to a transport means 64, with which the casting mould 44 can be transported away.

### LIST OF REFERENCE NUMBERS

1 casting mould
2 casting mould part
3 casting mould part
4 upper side
5 partial cavity
6 arrow
7 arrow
8 mould cavity
9 arrow
10 outer wall
11 underside
12 divider
13 divider
14 divider
15 casting mould part
16 casting mould part
17 partial cavity
18 partial cavity
19 sugar mass
20 mould cavity
21 annular rim
22 annular rim
23 cross section
24 separating wedge
25 separating surface
26 inner side
27 outer side
28 sugar mass
29 mound
30 surface
31 second ingredient
32 rising straight line
33 sharp bend
34 falling straight line
35 rising straight line
36 sharp bend
37 horizontal line
38 sharp bend
39 falling straight line
40 straight line
41 polynomial function
42 maximum
43 device
44 casting mould
45 casting mould part
46 casting mould
47 handling unit
48 pivoting mechanism
49 pivoting carrier
50 pivoting carrier
51 pivot drive
52 pivot drive
53 holding mechanism
54 holding mechanism
55 magnet
56 magnet
57 partial cavity
58 partial cavity
59 control unit
60 transport means
61 arrow
62 arrow
63 arrow
64 transport means
F_{S} gravity
F_{T} inertia force
F_{Z} centrifugal force
G casting machine
G1 graph
G2 graph
G3 graph
G4 graph
G5 graph
G6 graph
G7 graph
G8 graph
G9 graph
PG casting position
PT transport position
PZ intermediate position
Q centring opening
T axis of rotation
Z centring pin

1. A method for producing a three-dimensional confectionery item from at least one sugar mass (19, 28) using a casting mould (1), which can be assembled from at least two casting mould parts (2, 3, 15, 16), wherein each casting mould part has at least one partial cavity (5, 17, 18), with the proviso that the two casting mould parts (2, 3, 15, 16) can be brought into an assembled state in which the two partial cavities (5, 17, 18) produce a common mould cavity (8, 20) which gives the confectionery item its three-dimensional shape, wherein the two casting mould parts (2, 3, 15, 16) are arranged in an open casting position (PG) in which the partial cavities (5, 17, 18) are arranged so as to be open at the top, that, in the casting position (PG), a portion of the sugar mass (19, 28) of the confectionery item is poured into both partial cavities (5, 17, 18) of the casting mould parts (2, 3, 15, 16), that the two casting mould parts (2, 3, 15, 16) are then put together and brought into a closed transport position (PT) in which the casting mould is arranged horizontally, wherein the upper side (4) of one casting mould part (2, 3, 15, 16) comes into contact with the upper side of the other casting mould part (2, 3, 15, 16) and the partial cavities (5, 17, 18) of the two casting mould parts (2, 3, 15, 16) have lined up and form the common mould cavity (8, 20) wherein the casting mould is formed as a reusable permanent mould and, after the sugar mass (19, 28) has been poured in, the two casting mould parts (2, 3, 15, 16) of the permanent mould are moved first of all from the open casting position (PG) into a closed intermediate position (PZ) in a closing movement, in that, in the closed intermediate position (PZ), the partial cavities (5, 17, 18) of the two casting mould parts (2, 3, 15, 16) are already lined up and the common mould cavity (8, 20) is formed, and in that, in a pivoting movement, the casting mould is then moved from the closed intermediate position (PZ) into the horizontal transport position (PT).

2. The method according to claim 1, wherein the closing movement for putting the two casting mould parts (2, 3, 15, 16) together into the intermediate position (PZ) is performed in a time-controlled manner such that an accelerated and a decelerated movement phase are performed until the intermediate position (PZ) is reached, wherein the closing movement is performed accelerated at the start of the closing movement out of the casting position (PG) and is performed decelerated before the upper sides (4) of the casting mould parts (2, 3, 15, 16) come into contact.

3. The method according to claim 1, wherein, during the closing movement, the casting mould parts (2, 3, 15, 16) are rotated towards one another symmetrically about an axis of rotation (T) into the intermediate position (PZ).

4. The method according to claim 1, wherein the closing movement of the casting mould parts (2, 3, 15, 16) into the intermediate position (PZ) is carried out so quickly that poured-in sugar masses (19, 28) in the two partial cavities (5, 17, 18) can still join to one another when the partial cavities (5, 17, 18) have been lined up and the casting mould (1) is closed.

5. The method according to claim 4, wherein the closing movement until reaching the intermediate position (PZ), in which the partial cavities (5, 17, 18) of the casting mould parts (2, 3, 15, 16) are brought into overlapping, is performed within a closing time which is in the range of 0.1 to 3 seconds.

6. The method according to claim 4, wherein the pivoting movement of the casting mould (1) from the intermediate position (PZ) into the transport position (PT) is performed within a depositing time which lies in the range of from 0.1 to 3 seconds.

7. The method according to claim 1, wherein two different sugar masses (19, 28, 31) are poured into at least one partial cavity (5, 17, 18) of a casting mould part (2, 3, 15, 16), and in that the different sugar masses (19, 28, 31) are poured into the partial cavity (5, 17, 18) next to one another or one on top of the other.

8. The method according to claim 1, wherein the sugar mass (19, 28, 31) is poured into the partial cavities (5, 17, 18) of the casting mould parts (2, 3, 15, 16) at a pouring temperature in a particular temperature range, depending on its composition, namely:
for pectin gel 70-100° C.,
for gelatin 50-90°°C.,
for carrageenan 90-110° C.,
for agar 35-70° C.,
for hard caramel 80-150° C., and
for toffee or soft caramel 80-120° C.

9. The device for producing a three-dimensional confectionery item, the device comprising:
at least one casting mould (1) having at least two casting mould parts (2, 3, 15, 16) which can be assembled, wherein each of the casting mould parts (2, 3, 15, 16) is provided with at least one partial cavity (5, 17, 18), wherein, when they are lined up, the partial cavities (5, 17, 18) form a mould cavity (8, 20); and
a handling unit including
a holding mechanism for at least one of the casting mould parts (2, 3, 15, 16), and
a pivoting mechanism with which the casting mould part (2, 3, 15, 16) is movable;
a control unit is configured to control movement dynamics for a closing movement of the casting mould parts (2, 3, 15, 16) from a casting position (PG) into a intermediate position (PZ) and the movement dynamics for a pivoting movement of the casting mould parts (2, 3, 15, 16) from the intermediate position into a transport position (PT).

10. The device according to claim 9, wherein at least one casting mould part (2, 3, 15, 16) has on an upper side (4) an annular rim (21, 22) which surrounds the partial cavity (5, 17, 18) and protrudes at the upper side (4).

11. The device according to claim 10, wherein the annular rim (21, 22) is formed as a separating wedge (24).

12. The device according to claim 9, wherein the casting mould (2, 3, 15, 16) is provided with a positioning means in order to align the two casting mould parts (2, 3, 15, 16) relative to one another when the upper sides thereof come into contact with one another.

13. The device according to claims 12, wherein the positioning means includes magnets or centring pins (Z) and complementary centring openings (Q) are provided as positioning means.

14. The device according to claim 9, wherein at least one of the casting mould parts (2, 3, 15, 16) is a permanent mould made of a rigid plastic.

15. Method according to claim 1, wherein the sugar mass (19, 28, 31) is poured into the partial cavities (5, 17, 18) of the casting mould parts (2, 3, 15, 16) at a pouring temperature in a temperature range of 65-75° C. for gelatin.

16. Method according to claim 1, wherein the sugar mass (19, 28, 31) is poured into the partial cavities (5, 17, 18) of the casting mould parts (2, 3, 15, 16) at a pouring temperature in a temperature range of 100-110° C. for carrageenan.

17. Method according to claim 1, wherein the sugar mass (19, 28, 31) is poured into the partial cavities (5, 17, 18) of the casting mould parts (2, 3, 15, 16) at a pouring temperature in a temperature range of 45-55° C. for agar.

18. Method according to claim 1, wherein the sugar mass (19, 28, 31) is poured into the partial cavities (5, 17, 18) of the casting mould parts (2, 3, 15, 16) at a pouring temperature in a temperature range of 120-140° C. for hard caramel.

19. Method according to claim 1, wherein the sugar mass (19, 28, 31) is poured into the partial cavities (5, 17, 18) of the casting mould parts (2, 3, 15, 16) at a pouring temperature in a temperature range of 90-110° C. for toffee or soft caramel.
